(19) United States
(12) Patent Application Publication
(10) Pub. No.: US 2018/0089992 A1
(43) Pub. Date: Mar. 29, 2018

(54) SYSTEM AND METHOD FOR ROAD TRAFFIC CONDITION ESTIMATION

(71) Applicants: Kabushiki Kaisha Toshiba, Minato-ku (JP); Toshiba Infrastructure Systems & Solutions Corporation, Kawasaki-shi (JP)

(72) Inventors: Yoshikazu OOBA, Hachioji (JP); Hideki Ueno, Urayasu (JP)

(73) Assignees: Kabushiki Kaisha Toshiba, Minato-ku (JP); Toshiba Infrastructure Systems & Solutions Corporation, Kawasaki-shi (JP)

(21) Appl. No.: 15/698,986

(22) Filed: Sep. 8, 2017

(30) Foreign Application Priority Data
Sep. 29, 2016 (JP) 2016-191477

(51) Int. Cl. G08G 1/01; G08G 1/04; G08G 1/052; G08G 1/065

(52) U.S. Cl. CPC G08G 1/0112; G08G 1/0141; G08G 1/065; G08G 1/052; G08G 1/04

(57) ABSTRACT

According to one embodiment, a road traffic condition estimation system includes a storage, an inter-vehicle distance estimator, a vehicle density estimator, and a traffic flow rate estimator. The storage stores a speed and inter-vehicle distance table representing a relationship between vehicle speeds and inter-vehicle distances. The inter-vehicle distance estimator acquires a representative value of speeds of vehicles traveling on a given section of a road, and estimates a representative value of inter-vehicle distances on the section on the basis of the representative value of the speeds and the speed and inter-vehicle distance table. The vehicle density estimator estimates a vehicle density on the section on the basis of the estimated representative value of the inter-vehicle distances and a length of the section. The traffic flow rate estimator estimates a traffic flow rate on the section on the basis of the representative value of the speeds and the estimated vehicle density.

### CROSS-REFERENCE TO RELATED APPLICATIONS

This application is based upon and claims the benefit of priority from Japanese Patent Application No. 2016-191477, filed Sep. 25, 2016, the entire contents of which are incorporated herein by reference.

### FIELD

Embodiments described herein relate generally to a road traffic condition estimation system and a road traffic condition estimation method.

### BACKGROUND

Conventionally, in order to understand a traffic condition of a given road section (road traffic condition), road traffic control centers or similar facilities, for example, acquire three sets of information, i.e., a representative value of speed [km/h] (such as average speed, hereinafter may be simply referred to as speed), vehicle density [number of vehicles/km], and traffic flow rate [number of vehicles/h] of vehicles traveling on the road section concerned (disclosed in Japanese Patent No. 5667944).

Such a road traffic control center can calculate the three sets of information from measured values from vehicle sensors installed along the road, by way of example. The road traffic control center does not need to directly acquire all the three sets of information, and can calculate the last set of information from the two sets of information by a known equation:

traffic flow rate−vehicle density×vehicle speed.

However, the road traffic control center cannot obtain the three-sets of information on the roads with no vehicle sensors installed. From another perspective, probe information is now available from probe cars. Probe information generally contains vehicle speed information, however, may not contain information needed for calculating vehicle density or traffic flow rate. Based on the probe information, the road traffic control center can obtain accurate vehicle speed information in real time but cannot obtain accurate vehicle density and traffic flow rate information in real time.

An object of the present invention is to provide real-time, accurate estimates of vehicle density information and traffic flow rate information about a given road section even if only the representative value of vehicle speed is available.

### BRIEF DESCRIPTION OF THE DRAWINGS

FIG. 1 shows an exemplary configuration of a road traffic condition estimation system according to a first embodiment;

FIG. 2 is a schematic diagram of a road section in the first embodiment by way of example;

FIG. 3A shows an exemplary speed and inter-vehicle distance table;

FIG. 3B is a graph representing the speed and inter-vehicle distance table of FIG. 3A;

FIG. 4 is a flowchart of the road traffic condition, estimation in the first embodiment;

FIG. 5 shows an exemplary configuration of a road traffic condition estimation system according to a second embodiment;

FIG. 6 shows an exemplary configuration of a road traffic condition estimation system according to a third embodiment;

FIG. 7 shows an exemplary configuration of a road traffic condition estimation system according to a fourth embodiment; and

FIG. 8 shows an exemplary configuration of a road traffic condition estimation system according to a fifth embodiment.

### DETAILED DESCRIPTION

A road traffic condition estimation system according to one embodiment generally includes a storage, an inter-vehicle distance estimator, a vehicle density estimator, and a traffic flow rate estimator. The storage stores a speed and inter-vehicle distance table representing a relationship between vehicle speeds and inter-vehicle distances. The inter-vehicle distance estimator acquires a representative value of speeds of vehicles traveling on a given section of a road, and estimates a representative value of inter-vehicle distances on the section on the basis of the representative value of the speeds and the speed and inter-vehicle distance table. The vehicle density estimator estimates a vehicle density on the section on the basis of the estimated representative value of the inter-vehicle distances and a length of the section. The traffic flow rate estimator estimates a traffic flow rate on the section on the basis of the representative value of the speeds and the estimated vehicle density.

Hereinafter, first to fifth embodiments will be described with reference to the accompanying drawings. Throughout the embodiments, same or like elements will be denoted by same or like reference numerals and a redundant description thereof will be avoided when appropriate.

### First Embodiment

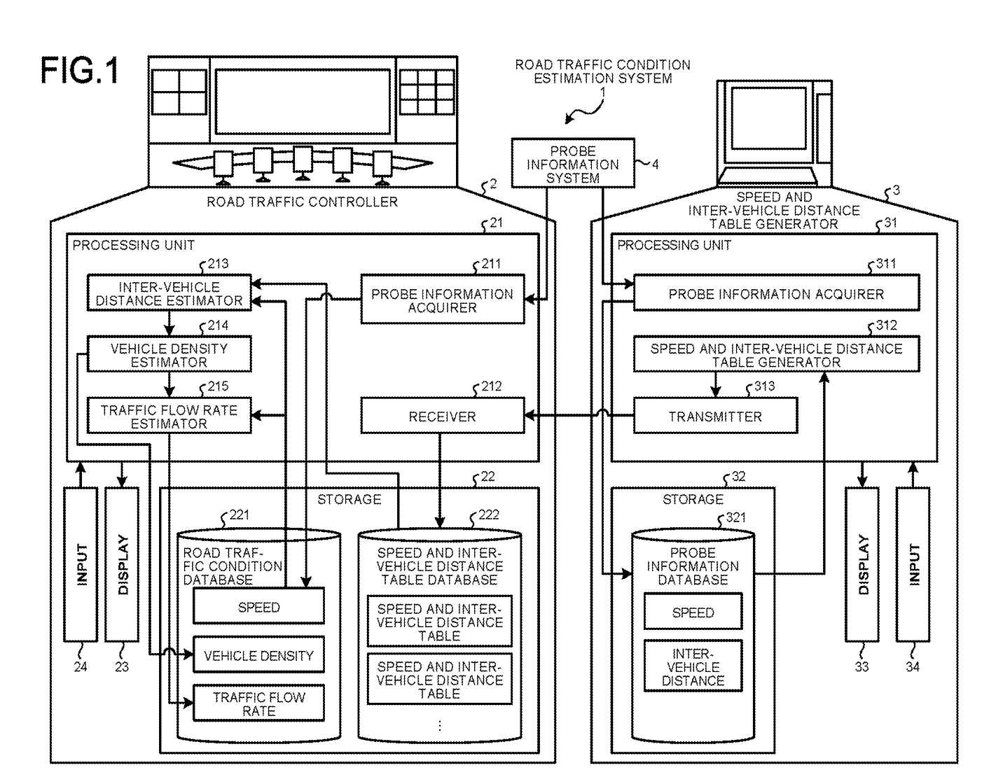

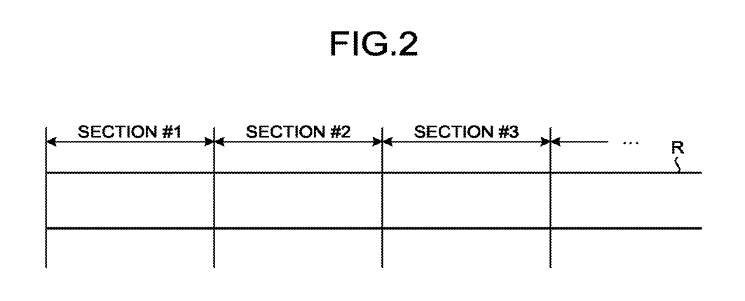

First, referring to FIGS. 1 and 2, an exemplary configuration of a road traffic condition estimation system 1 according to a first embodiment is described. FIG. 1 shows an example of the road traffic condition estimation system 1 in the first embodiment. FIG. 2 is a schematic diagram of a road section in the first embodiment by way of example.

The road traffic condition estimation system 1 in FIG. 1 functions to accurately estimate, in real time, information on a vehicle density [number of vehicles/km] and a traffic flow rate [number of vehicles/h] about each of given sections #1, #2, #3, . . . of a road R, as shown in FIG. 2, when only the representative value (such as average speed) of vehicle speeds is available.

The road traffic condition estimation system 1 includes a road traffic controller 2 and a speed and inter-vehicle distance table generator 3. The road traffic controller 2 and the speed and inter-vehicle distance table generator 3 acquire probe information from an external probe information system 4. Herein, probe information refers to information including positions, speeds, and distances of vehicles transmitted from probe cars. Probe cars refer to vehicles provided with information transmitting function.

Although all the probe cars transmit vehicle position and speed information, only part of the probe cars can transmit inter-vehicle distance information. That is, the road traffic condition estimation system 1 can obtain real-time, accurate vehicle speed information about an intended section (hereinafter, may be simply referred to as section) on the basis of the probe information, however, may not obtain real-time, accurate inter-vehicle distance information. The inter-vehicle distance information in the probe information is used to generate a speed and inter-vehicle distance table, as described later.

The road traffic controller 2 represents, for example, a computer system as generally referred to as a road traffic control system. For the sake of simple explanation, the road traffic controller 2 is depicted as a single computer in FIG. 1, however, it can be implemented by multiple computers.

The road traffic controller 2 includes a processing unit 21, a storage 22, a display 23, and an input 24. The road traffic controller 2 also includes a communicator for communicating with external devices, although neither shown nor described for the sake of simplicity.

The processing unit 21 controls the overall operation of the road traffic controller 2 to implement various functions of the road traffic controller 2. The processing unit 21 includes a CPU (central processing unit), a ROM (read only memory), and a RAM (random access memory), for instance. The CPU integrally controls the operation of the road traffic controller 2. The ROM is a storage medium that stores various types of programs and data. The RAM is a storage medium for data rewrites and temporarily storing various programs. The CPU uses the RAM as a work area to execute the programs stored in the ROM and the storage 22. The processing unit 21 includes a probe information acquirer 211, a receiver 212, an inter-vehicle distance estimator 213, a vehicle density estimator 214, and a traffic flow rate estimator 215.

The probe information acquirer 211 acquires vehicle probe information from the probe information system 4 via a communication network, and stores the speed information of vehicles present on the intended section in a road traffic condition database 221 of the storage 22.

The receiver 212 receives a speed and inter-vehicle distance table (as described in detail later) from a transmitter 313 of the speed and inter-vehicle distance table generator 3 and stores it in a speed and inter-vehicle distance table database 222 of the storage 22. When receiving two or more speed and inter-vehicle distance tables, the receiver 212 stores them in the speed and inter-vehicle distance table database 222 together with their identification information.

The inter-vehicle distance estimator 213 estimates, a representative value (such as average inter-vehicle distance) of the inter-vehicle distances among vehicles traveling on the intended section on the basis of the vehicle speed (representative value) stored in the road traffic condition database 221 and the speed and inter-vehicle distance table stored in the speed and inter-vehicle distance table database 222.

The vehicle density estimator 214 estimates a vehicle density on the section from the estimated representative value of inter-vehicle distances by the inter-vehicle distance estimator 213 and the length of the section stored in the storage 22.

The traffic flow rate estimator 215 estimates the traffic flow rate on the section from the vehicle speed stored in the road traffic condition database 221 and the estimated vehicle density by the vehicle density estimator 214. For example, the traffic flow rate estimator 215 multiplies the speed stored in the road traffic condition database 221 by the estimated vehicle density by the vehicle density estimator 214 for estimating the traffic flow rate on the section.

The storage 22 is a storage medium such as a HDD (hard disk drive) or an SSD (solid state drive). The storage 22 contains the road traffic condition database 221 and the speed and inter-vehicle distance table database 222.

The road traffic condition database 221 stores speeds, vehicle densities, and traffic flow rates as necessary information for understanding a traffic condition of each road section.

The speed and inter-vehicle distance table database 222 stores one or more speed and inter-vehicle distance tables. The speed and inter-vehicle distance tables represent the relationship between the vehicle speed and the inter-vehicle distance, as described in detail later.

The storage 22 stores the length of each section, for example, in addition to the above sets of information.

The display 23 displays various kinds of information and is exemplified by an LCD (liquid crystal display) or an organic EL (electro-luminescence) device. The input 24 is a device through which a user operates the road traffic controller 2, and exemplified by a keyboard and a mouse.

The speed and inter-vehicle distance table generator 3 is a computer device that generates a speed and inter-vehicle distance table. The speed and inter-vehicle distance table generator 3 includes a processing unit 31, a storage 32, a display 33, and an input 34. The speed and inter-vehicle distance table generator 3 further includes a communicator for communication with external devices, although neither shown nor described for the sake of simplicity.

The processing unit 31 controls the overall operation of the speed and inter-vehicle distance table generator 3 to implement various functions of the speed and inter-vehicle distance table generator 3. The processing unit 31 includes a CPU, a ROM, and a RAM. The CPU integrally controls the operation of the speed and inter-vehicle distance table generator 3. The ROM is a storage medium that stores various types of programs and data. The RAM is a storage medium for data rewrites and temporarily storing various programs. The CPU uses the RAM as a work area to execute the programs stored in the ROM and the storage 32. The processing unit 31 includes a probe information acquirer 311, a speed and inter-vehicle distance table generator 312, and a transmitter 313.

The probe information acquirer 311 acquires vehicle probe information from the probe information system 4 via a communication network, and accumulates vehicle speed information and inter-vehicle distance information about vehicles present on the section concerned in the probe information database 321 of the storage 32.

The inter-vehicle distance information is obtained from a probe car equipped with an image sensor to calculate the inter-vehicle distance according to data from the image sensor. The probe car includes multiple cameras having known parallaxes for capturing an image of a vehicle ahead, and a device that calculates the distance from the probe car to the vehicle ahead as the inter-vehicle distance according to the captured image of the vehicle ahead.

Additionally, the inter-vehicle distance information is obtained from a probe car which includes a reflective electromagnetic sensor such as a millimeter-wave sensor to calculate the inter-vehicle distance from measurements of the electromagnetic sensor. In this case the device of the probe car calculates the inter-vehicle distance between the probe car and the vehicle ahead from a length of time from the emission of a millimeter wave from the millimeter-wave sensor to the return of a reflected wave by the vehicle ahead.

The speed and inter-vehicle distance table generator 312 generates a speed and inter-vehicle distance table on the basis of the vehicle speeds and the inter-vehicle distances accumulated in the probe information database 321, and transfers the table to the transmitter 313.

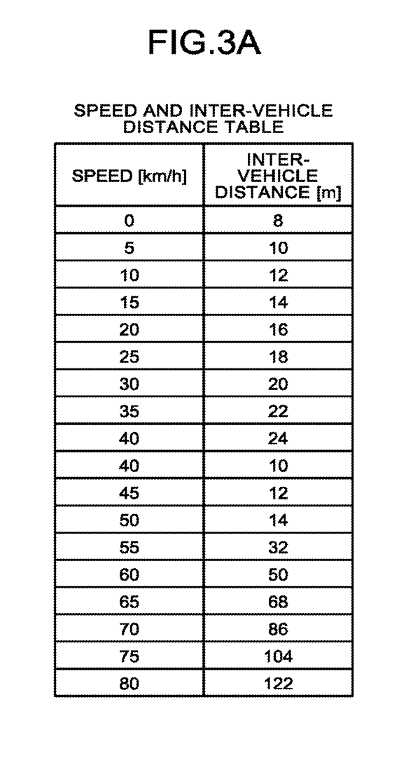

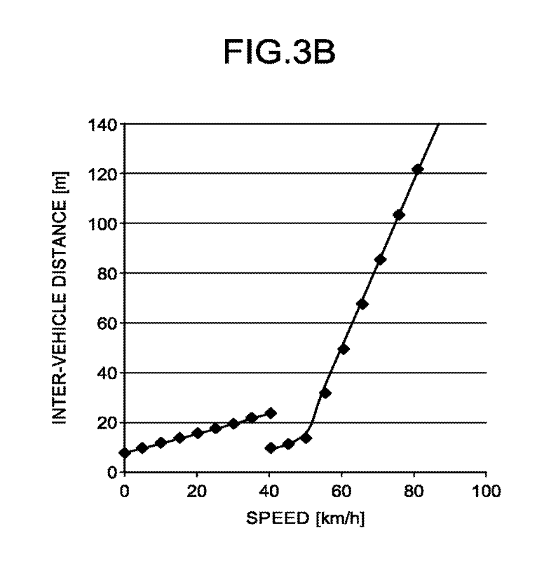

Now, referring to FIG. 3A and FIG. 3B, the speed and inter-vehicle distance table is described. FIG. 3A shows one example of the speed and inter-vehicle distance table in the first embodiment. FIG. 3B is a graph representing the speed and inter-vehicle distance table in FIG. 3A.

As shown in FIG. 3A, the speed and inter-vehicle distance table lists the speed [km/h] and the inter-vehicle distance [m] in association with each other. The speed and inter-vehicle distance table generator 312 generates the speed and inter-vehicle distance table on the basis of the speeds and the inter-vehicle distances accumulated in the probe information database 321 by, for instance, statistical processing using a least-square method. In FIG. 3A and FIG. 3B the speed data increments by five km/h for the sake of simple explanation, however, it can be set by smaller increments. There are two speed data items “40 km/h” corresponding to different inter-vehicle distances. This is intended for the speed and inter-vehicle distance table generator 312 to use, as the inter-vehicle distance, “24 m” when the vehicle speeds up to 40 km/h and use “10 m” when the vehicle slows down to 40 km/h.

Referring back to FIG. 1, the transmitter 313 transmits the speed and inter-vehicle distance table generated by the speed and inter-vehicle distance table generator 312 to the receiver 212 of the road traffic controller 2.

The storage 32 is a storage medium such as an HDD or an SSD. The storage 32 contains the probe information database 321. The probe information database 321 stores, in sequence, the vehicle speed information and the inter-vehicle distance information for each of the sections calculated by the probe information acquirer 311.

The display 33 displays various kinds of information and is exemplified by an LCD or an organic EL device. The input 24 is a device through which a user operates the speed and inter-vehicle distance table generator 3, and is exemplified by a keyboard and a mouse.

The speed and inter-vehicle distance table is stored in the speed and inter-vehicle distance table database 222 of the storage 22 of the road traffic controller 2, as described above. Alternatively, different speed and inter-vehicle distance tables can be provided for different regions, areas, or districts, for example, in view of different drivers' characteristics between Tokyo and Osaka which lead to different contents of the speed and inter-vehicle distance table depending on the regions.

Alternatively, different speed and inter-vehicle distance tables can be provided for different road sections, for example, in view of different characteristics of the sections such as road widths, curves, uphills, downhills, tunnels, or bridges, which lead to different contents of the speed and inter-vehicle distance table depending on the sections.

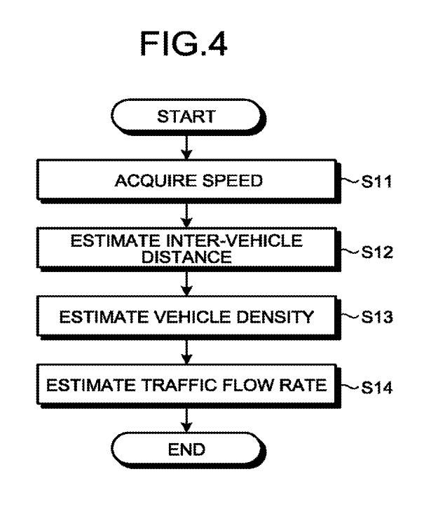

Next, the road condition estimation process by the road traffic controller 2 is described by way of example. FIG. 4 shows one example of the road condition estimation process in the first embodiment.

First, the inter-vehicle distance estimator 213 of the road traffic controller 2 acquires speed information on an intended section, referring to the road traffic condition database 221 (step S11).

The inter-vehicle distance estimator 213 then estimates a representative value of inter-vehicle distances on the section on the basis of the acquired speed information and the speed and inter-vehicle distance table stored in the speed and inter-vehicle distance table database 222 (step S12)

Next, the vehicle density estimator 214 estimates a vehicle density on the section from the representative value of inter-vehicle distances estimated in step 312 and the length of the section by, for example, the equation:

vehicle density [number of vehicles/km]=1000 [m]/inter-vehicle distance [m]

and stores a resultant in the road traffic condition database 221 (step S13). Alternatively, the vehicle density estimator 214 may use the following equation:

vehicle density [number of vehicles/km]=1000 [m]/(inter-vehicle distance [m]+average vehicle length [m]).

Next, the traffic flow rate estimator 215 estimates the traffic flow rate on the section concerned on the basis of the speed information and the vehicle density estimated in step S13, for example, by multiplying them (traffic flow rate [number of vehicles/h]=vehicle density [number of vehicles/km]×speed [km/h]), and stores a resultant in the road traffic condition database 221 (step S14).

Thus, the road traffic condition estimation system 1 according to the first embodiment can accurately estimate or predict the vehicle density information and the traffic flow rate information on a given road section in real time from the information on the representative value of vehicle speeds alone. Thereby, the road traffic condition estimation system 1 can generate traffic congestion information or required travel time information from the speed, vehicle density, and traffic flow rate information for providing a service to users to support and assist efficient usage of roads.

The speed and inter-vehicle distance table generated by the speed and inter-vehicle distance table generator 3 can be implemented on the road traffic controller 2 through an information storage medium such as a DVD (digital versatile dish) or a USB (universal serial bus) memory, in addition to the above method.

### Second Embodiment

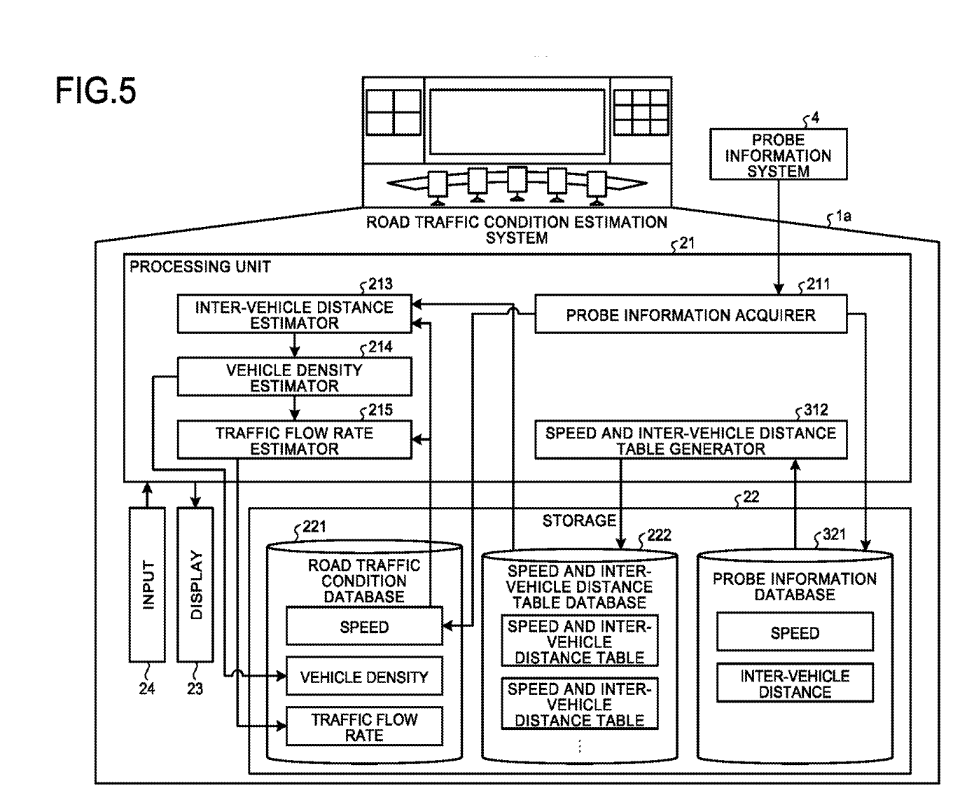

Next, referring to FIG. 5, a road traffic condition estimation system 1a according to a second embodiment is described. FIG. 5 shows an exemplary configuration of the road traffic condition estimation system 1a in the second embodiment. The road traffic condition estimation system 1a in FIG. 5 is equivalent to the integration of the road traffic controller 2 and the speed and inter-vehicle distance table generator 3 of the road traffic condition estimation system 1 in FIG. 1. The road traffic condition estimation system 1a can be implemented by a conventional road traffic control system, for example.

Specifically, the road traffic condition estimation system 1a includes a processing unit 21, a storage 22, a display 23, and an input 24. The processing unit 21 includes a probe information acquirer 211, an inter-vehicle distance estimator 213, a vehicle density estimator 214, a traffic flow rate estimator 215, and a speed and inter-vehicle distance table generator 312. The storage 22 contains a road traffic condition database 221, a speed and inter-vehicle distance table database 222, and a probe information database 321. The individual configurations as elements and databases and their processing are identical to those in the first embodiment, therefore, a description thereof is omitted.

In addition to the effects of the road traffic condition estimation system 1 in the first embodiment, the road traffic condition estimation system 1a of the second embodiment can attain the following effects:

being a unitary system, the road traffic condition estimation system 1 can be simplified in configuration and processing; and

the road traffic condition estimation system 1a can readily update the speed and inter-vehicle distance table using the probe information accumulated in sequence in the probe information database 321.

### Third Embodiment

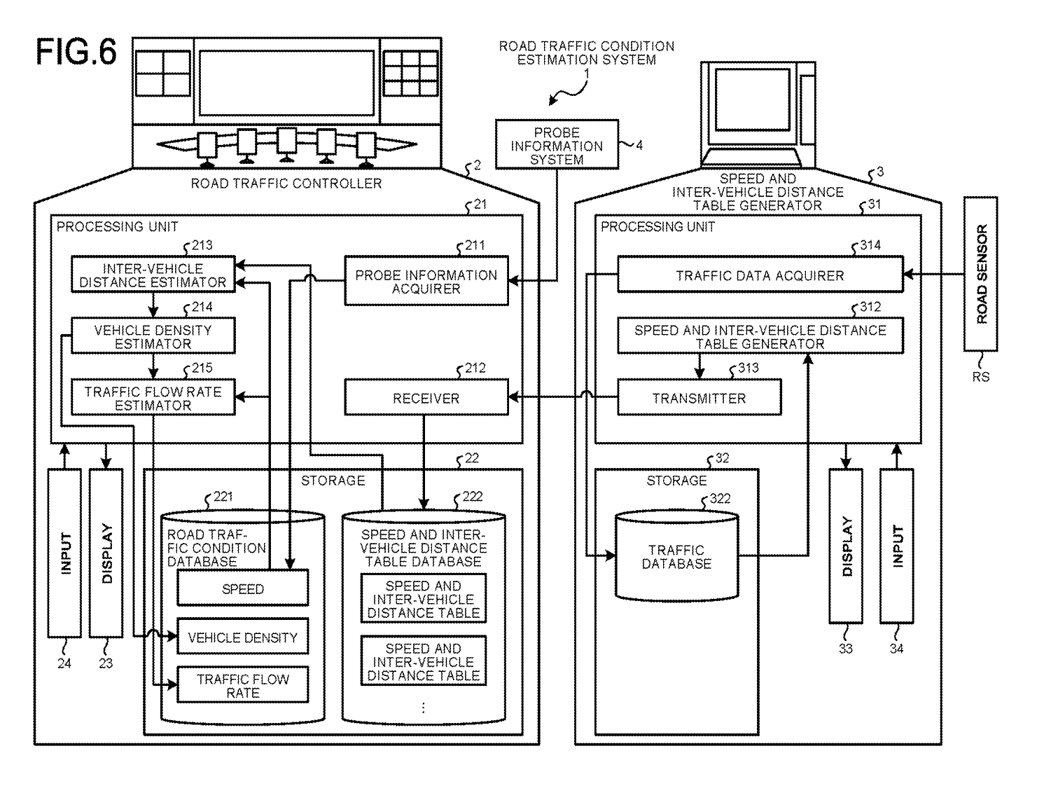

Now, with reference to FIG. 6, a road traffic condition estimation system 1 according to a third embodiment is described. FIG. 6 shows an exemplary configuration of the road traffic condition estimation system 1 in the third embodiment.

The road traffic condition estimation system 1 in FIG. 6 differs from the road traffic condition estimation system 1 in FIG. 1 in that the speed and inter-vehicle distance table generator 3 excludes the probe information acquirer 311 and the probe information database 321 and additionally includes a traffic data acquirer 314 and a traffic database 322. The road traffic condition estimation system 1 of the third embodiment generates the speed and inter-vehicle distance table from information gathered by a road sensor RS installed along a road with a structure similar to an intended section. The differences from the first embodiment are described below.

The road sensor RS includes a sensing device and a traffic data processing unit by way of example. The sensing device includes at least any or a combination of a loop coil installed under the road surface, a camera that captures the road surface from above, and an ultrasonic sonar, to measure passages of vehicles, for example.

The traffic data processing unit calculates traffic data containing traffic flow rate [number of vehicles/h], vehicle speed (average) [km/h], and vehicle density [number of vehicles/km] of traveling vehicles on the basis of measured values from the sensing device, and transmits the traffic data to the speed and inter-vehicle distance table generator 3. Such calculation and transmission are executed in unit of one minute or five minutes, for example.

The traffic data acquirer 314 acquires the traffic data from the road sensor RS for storing in the traffic database 322 of the storage 32. The traffic database 322 stores the traffic data.

The speed and inter-vehicle distance table generator 312 generates a speed and inter-vehicle distance table on the basis of the traffic data in the traffic database 322. With only the traffic flow rate and vehicle speed of the traffic data available, the speed and inter-vehicle distance table generator 312 uses the vehicle speed without calculations and calculates an inter-vehicle distance by the following equations:

vehicle density [number of vehicles/km]=traffic flow rate [number of vehicles/h]/speed [km/f]

inter-vehicle distance [m]=1,000 [m]/vehicle density [number of vehicles/km].

The rest of the operation is the same as in the first embodiment, therefore, a description thereof is omitted.

As described above, the road traffic condition estimation system 1 of the third embodiment can generate accurate speed and inter-vehicle distance tables using the traffic data on the road with a similar structure to the intended section. Referring to the speed and inter-vehicle distance tables, the road traffic condition estimation system 1 can accurately estimate real-time vehicle density information and traffic flow rate information on a given road section from the information on the representative value of the vehicle speeds alone.

### Fourth Embodiment

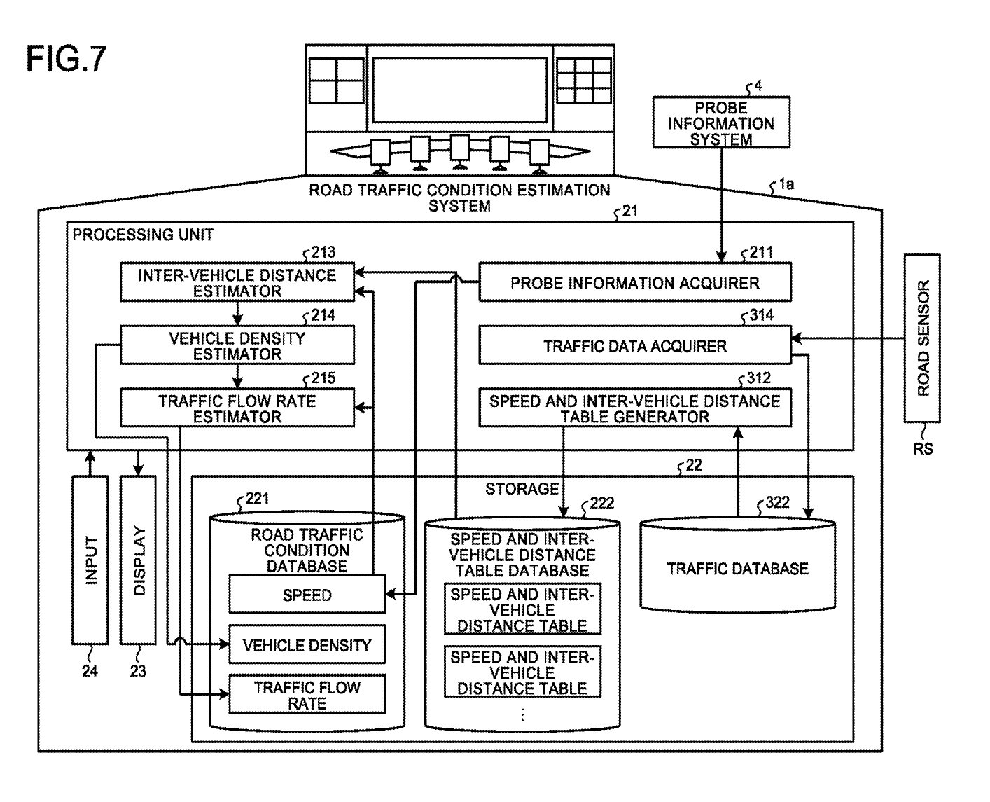

Next, referring to FIG. 7, a road traffic condition estimation system 1a according to a fourth embodiment is described. FIG. 7 shows an exemplary configuration of the road traffic condition estimation system 1a in the fourth embodiment. As with the road traffic condition estimation system 1a in FIG. 5 that is the integrated road traffic controller 2 and speed and inter-vehicle distance table generator 3 in FIG. 1, the road traffic condition estimation system 1a in FIG. 7 is the integration of the road traffic controller 2 and the speed and inter-vehicle distance table generator 3 in FIG. 6. The individual configurations as elements and databases and processing of the road traffic condition estimation system 1a in FIG. 7 are the same as those of the third embodiment, therefore, a description thereof is omitted.

Thus, being a unitary system, the road traffic condition estimation system 1a in the fourth embodiment can be effectively simplified in configuration and processing in addition to the effects of the third embodiment.

### Fifth Embodiment

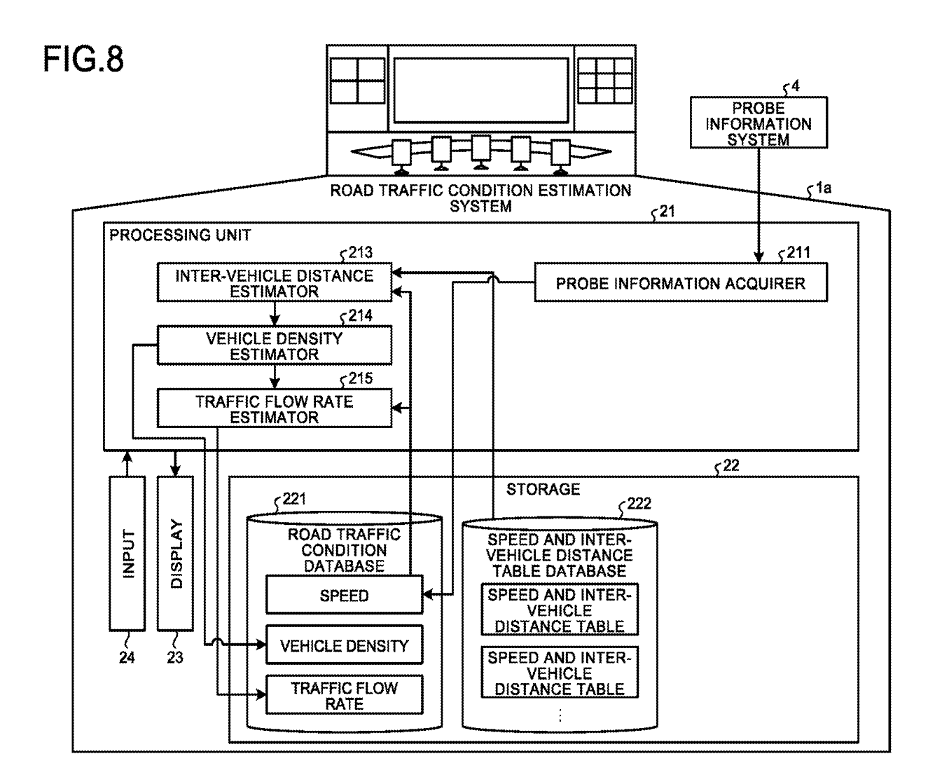

Next, with reference to FIG. 8, a road traffic condition estimation system 1a according to a fifth embodiment is described. FIG. 8 shows an exemplary configuration of the road traffic condition estimation system 1a in the fifth embodiment. The road traffic condition estimation system 1a in the fifth embodiment differs from the ones of the first to fourth embodiments in that the speed and inter-vehicle distance table is generated by a theoretical model. The road traffic condition estimation system 1a in FIG. 8 omits the speed and inter-vehicle distance table generator 312 and the probe information database 321 in comparison with the road traffic condition estimation system 1a of the second embodiment in FIG. 5.

According to statistics, the relationship between the vehicle speed and the inter-vehicle distance on the roads, as shown in the graph of FIG. 3B, is established. The road traffic condition estimation system 1a of the present embodiment generates a theoretical model including two discontinuous lines as shown in FIG. 3B. The two discontinuous lines are assumed to appear because of the following two major reasons:

first, macroscopically, there are two road conditions, traffic congestion and non-congestion, and the characteristics of traveling vehicles differ in the two conditions; and

second, microscopically, there are two kinds of traveling vehicles, freely traveling vehicles (free from restriction from vehicles ahead) and following vehicles (restricted by vehicles ahead), and the characteristics of the two kinds of traveling vehicles differ from each other.

The rest of the operation in the present embodiment is the same as that of the second embodiment, therefore, a description thereof is omitted.

Hence, the road traffic condition estimation system 1a of the fifth embodiment can generate further accurate speed and inter-vehicle distance tables using the discontinuous linear model than using a single continuous linear model. In developing countries, for example, the probe information or the information from road sensors may be unavailable for generating the speed and inter-vehicle distance tables. However, the road traffic condition estimation system 1a can accurately estimate real-time vehicle density and traffic flow rate from the vehicle speed alone, referring to the speed and inter-vehicle distance table based on the discontinuous linear model.

The first to fifth embodiments may adopt the following method. For example, for calculation of the vehicle density, the road traffic condition estimation systems may use an average vehicle length, taking into account the ratio of large-size vehicles to all kinds of vehicles, if the ratio is found from the information from the road sensor RS or the results of road traffic survey.

The speed and inter-vehicle distance table generators 3 in FIGS. 1 and 6 can be cloud-based using cloud computing technology.

Each of the road traffic condition estimation systems may adopt the discontinuous linear model in FIG. 3B for generating the speed and inter-vehicle distance tables from the probe information or the information from the road sensor RS.

Each of the road traffic condition estimation systems may generate different speed and inter-vehicle distance tables in different situations (A) to (D), as follows.

(A) At higher or lower level of sunlight as during daytime hours and evening hours: different speed and inter-vehicle distance tables are generated during turning-on and turning-off of vehicle headlights, for example.

(B) Depending on season or weather: different speed and inter-vehicle distance tables are generated during snowfalls and during non-snowfalls or depending on the state of a road surface, dry, wet, and icy, for example.

(C) Two or more lanes on the road: different speed and inter-vehicle distance tables are individually generated for the lanes.

(D) Depending on day of the week: different speed and inter-vehicle distance tables are generated for weekdays and for weekend or holidays, for example.

A traffic volume can be used instead of the traffic flow rate.

A space headway can be calculated, for example from the average vehicle length of all vehicles lengths. In this case, a relationship between vehicle speeds and space headways can be regarded as equivalent to a relationship between vehicle speeds and inter-vehicle distances, so that the space headway can be used instead of the inter-vehicle distance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A road traffic condition estimation system that estimates vehicle density information and traffic flow rate information, the system comprising:
a storage that stores a speed and inter-vehicle distance table representing a relationship between vehicle speeds and inter-vehicle distances;
an inter-vehicle distance estimator that acquires a representative value of speeds of vehicles traveling on a given section of a road, and estimates a representative value of inter-vehicle distances on the section on the basis of the representative value of the speeds and the speed and inter-vehicle distance table;
a vehicle density estimator that estimates a vehicle density on the section on the basis of the estimated representative value of the inter-vehicle distances and a length of the section; and
a traffic flow rate estimator that estimates a traffic flow rate on the section on the basis of the representative value of the speeds and the estimated vehicle density.

2. The road traffic condition estimation system according to claim 1, further comprising
a first speed and inter-vehicle distance table generator that acquires, as probe information, the inter-vehicle distances and the speeds from the vehicles traveling on the section, and generates, for storing in the storage, the speed and inter-vehicle distance table on the basis of the acquired speeds and inter-vehicle distances based on an on-vehicle image sensor.

3. The road traffic condition estimation system according to claim 1, wherein
the speed and inter-vehicle distance table is generated by a theoretical model and stored in the storage.

4. The road traffic condition estimation system according to claim 1, further comprising
a second speed and inter-vehicle distance table generator that acquirers, as probe information, the inter-vehicle distances and the speeds from the vehicles traveling on the section, and generates, for storing in the storage, the speed and inter-vehicle distance table on the basis of the acquired speeds and inter-vehicle distances based on an on-vehicle reflective electromagnetic sensor.

5. The road traffic condition estimation system according to claim 1, further comprising
a third speed and inter-vehicle distance table generator that generates, for storing in the storage, the speed and inter-vehicle distance table can the basis of information gathered by a road sensor, the road sensor installed along a road with a structure similar to the section.

6. The road traffic condition estimation system according to claim 1, wherein
the traffic flow rate estimator estimates the traffic flow rate on the section by multiplication of the representative value of the speeds and the estimated vehicle density.

7. The road traffic condition estimation system according to claim 1, wherein
the speed and inter-vehicle distance table is generated for each of different regions.

8. The road traffic condition estimation system according to claim 1, wherein
the speed and inter-vehicle distance table is generated for each of divided sections of the road.

9. A road traffic condition estimation method to be executed by a road traffic condition estimation system that estimates vehicle density information and traffic flow rate information, the method comprising:
acquiring a representative value of speeds of vehicles traveling on a given section of a road, and estimating a representative value of inter-vehicle distances on the section on the basis of the representative value of the speeds and a speed and inter-vehicle distance table stored in a storage, the inter-vehicle distance table representing a relationship between the vehicle speeds and the inter-vehicle distances;
estimating a vehicle density on the section on the basis of the estimated representative value of the inter-vehicle distances and a length of the section; and
estimating a traffic flow rate on the section on the basis of the representative value of the speeds and the estimated vehicle density.

10. The road traffic condition estimation method according to claim 9, further comprising
acquiring, as probe information, the inter-vehicle distances and the speeds from the vehicles traveling on the section, and generating, for storing in the storage, the speed and inter-vehicle distance table on the basis of the acquired speeds and inter-vehicle distances based on an on-vehicle image sensor.

11. The road traffic condition estimation method according to claim 9, wherein
the speed and inter-vehicle distance table is generated by a theoretical model and stored in the storage.

12. The road traffic condition estimation method according to claim 9, further comprising
acquiring in advance, as probe information, the inter-vehicle distances and the speeds from the vehicles traveling on the section, and generating, for storing in the storage, the speed and inter-vehicle distance table on the basis of the acquired speeds and inter-vehicle distances based on an on-vehicle reflective electromagnetic sensor.

13. The road traffic condition estimation method according to claim 9, further comprising
generating, for storing in the storage, the speed and inter-vehicle distance table on the basis of information gathered in advance by a road sensor, the road sensor installed along a road with a structure similar to the section

14. The road traffic condition estimation method according to claim 9, wherein
the traffic flow rate on the section is estimated by multiplication of the representative value of the speeds and the estimated vehicle density.

15. The road traffic condition estimation method according to claim 9, wherein
the speed and inter-vehicle distance table is generated for each of different regions.

16. The road traffic condition estimation method according to claim 9, wherein
the speed and inter-vehicle distance table is generated for each of divided sections of the road.
